(19) United States
(12) Patent Application Publication
(10) Pub. No.: US 2005/0263253 A1
(43) Pub. Date: Dec. 1, 2005

(54) Embossing machine

(76) Inventor: Armin Steuer, Waldenbuch (DE)

Correspondence Address: NATH & ASSOCIATES, PLLC, Sixth Floor, 1030 15th Street, N.W., Washington, DC, 20005, US

(21) Appl. No.: 11/135,462

(22) Filed: May 24, 2005

(30) Foreign Application Priority Data
May 26, 2004 (DE) 102004026890.8

(51) Int. Cl. B32B 31/04

(52) U.S. Cl. 156/553

(57) ABSTRACT

An embossing machine (11) for transferring holograms, etc. from a support foil (17) to a web or sheet (16) has a die cylinder (13) and a counterpressure cylinder (14) between which the printing gap (18) is adjustable by means of a rocker (23) mounting the die cylinder (13). A die cylinder electric drive (30) makes it possible by means of a three-phase motor supplied via a controllable frequency converter to move the die cylinder varying from the synchronous speed of the counterpressure cylinder. Reaction forces resulting from the acceleration and deceleration of the electric drive (30) are led off directly from the electric drive stator, via a bracket, to the machine frame.

The following disclosure is based on German Patent Application No. 10 2004 026 890.8 filed on May 26, 2005, which is herewith incorporated into this application by explicit reference.

### FIELD OF APPLICATION AND PRIOR ART

The invention relates to an embossing machine for transferring surface portions from a support web, such as a foil, to a substrate, such as a sheet or a continuous web of paper or other materials.

Such embossing machines, which are also called rotary cylinder presses, are used for embossing or transferring flat structures, such as e.g. holograms, areas of metallized foils or metal coatings, to a substrate, usually using a heat seal process. For this purpose the corresponding surface portion applied before to the support foil and provided with a heat seal coating the surface portion is detached from the foil and embossed by heat sealing on the substrate.

Such an embossing is shown and described in detail in DE 196 25 064 C2. It also describes a mechanical nonuniformity gear or transmission, which is connected between the die cylinder and the counterpressure cylinder and adjustably permits periodic changes to the circumferential speed of one of the cylinders during in each case one revolution. For the reasons described therein, this makes it possible at the time when a die on the die cylinder transfers the print image on the support web to the substrate, the circumferential speed of both cylinders is precisely the same, although there can be minor differences in the effective diameters of the two cylinders. Thus, e.g. in the case of a too small die cylinder, the latter is accelerated on moving up to the pressure time and is then decelerated again so that during the next revolution the registration stability is again ensured.

### OBJECT OF THE INVENTION

The object of the invention is to provide an embossing machine permitting the fulfilment of this function with reduced mechanical expenditure and which also provides further possibilities and improved adjustability.

This object is met by the invention.

### SUMMARY OF THE INVENTION

Thus, the invention makes use of an electric drive, mechanically decoupled from the second cylinder, usually the counterpressure cylinder, for the first cylinder, which is usually the die cylinder. In the case of sheet-fed machines the counterpressure cylinder also has the function of gripping the sheet and transporting it through the printing gap and is also connected to a series of follow-up units, so that here a precise positioning and maintaining of timing is necessary, which requires a fixed-oriented mounting with respect to the remainder of the machine.

However, the die cylinder can be adjustably movable with respect to its centre distance from the counterpressure cylinder and its effective diameter, which is defined by the surface of the dies fixed thereto, is dependent on the thickness thereof. In addition, during heat seal transfer the die cylinder is heated, so that thermal expansions arise, which play a part in the case of the printing gap setting which is precise to within hundredths of a millimetre. Thus, hitherto, the circumference of the counterpressure cylinder has had to be adapted in labour-costly manner by so-called tympans, i.e. sheets of different thickness not participating in the printing process.

With regards to the function of the nonuniformity drive and details of the embossing machine reference is made for disclosure purposes to the aforementioned DE 196 25 064 C2. The electric drive according to the invention, which is entirely mechanically decoupled from the synchronous drive of the remaining machine, is only control-dependent thereon, in that e.g. on the counterpressure cylinder or its drive are provided corresponding pick-ups, e.g. frequency pick-ups or the like. In an electronic control device, e.g. a computer, the data concerning the speed of the two cylinders are compared with one another and the desired periodic deviations are modified by means of a stored program inputted manually or in some other way. This allows a much greater flexibility concerning speed changes. Thus, e.g. in the case of several dies separated from one another in each case by an “idle path” and located on the circumference of the die cylinder, the speeds could be set corresponding often per revolution to the synchronous circumferential speed and in each case between them a corresponding time lag can be ensured, so that the resulting speed precisely coincides with that of the counterpressure cylinder, which is necessary for register accuracy. This is surprisingly possible, despite the lack of mechanical coupling.

The electric drive is preferably constituted by a three-phase motor, which determines the speed changes by means of a controllable frequency converter.

With the high operating speeds and correspondingly high rotational speeds, the electric drive has to transfer very considerable accelerations and decelerations to the die cylinder. These moments are normally transferred to the mounting support of the corresponding driven cylinder, which leads to vibrations and considerable shock loads on the adjusting members for the die cylinder. According to another feature of the invention the electric drive is an electric motor with a stator and a rotor, the stator being mounted on a machine part other than the first cylinder. If the first cylinder is mounted on an adjustable machine part, e.g. a rocker, the stator can e.g. be supported by means of a bracket on a machine-fixed part, i.e. on the machine frame, so that it transfers its reaction forces to the accelerating and decelerating movements directly to the machine frame and not to the rocker. Thus, the adjusting drive for the rocker, e.g. an electric linear motor or a hydraulic cylinder, is kept free from these vibrations and shock loads.

Preferably the bracket is vertical to the connection of the cylinder axis to the adjusting rocker axis and is connected by means of a slide fit to the machine frame. There is no need for such a slide fit if the bracket runs in the direction of said connecting line between the axes and the support thereof e.g. takes place on an extension of the rocker axis. In this case the bracket would be parallel to the rocker, but would support the stator independently of the rocker.

It is clear that as a result of the invention there are clear improvements to the adjustability and adaptation possibilities. It is not only possible to compensate minor diameter differences, but active intervention can take place in the embossing sequence. Not only can larger diameter differences be compensated, but instead effects can also be obtained which did not hitherto appear possible, e.g. also intervention is possible on the synchronism between the die cylinder, counterpressure cylinder and the two participating material webs, in order e.g. to produce an active “outline” on the edges of a die through circumferential speed differences.

Thus, preferably an embossing machine for transferring holograms, etc. from a support foil to a web or sheet is provided, which has a die cylinder and a counterpressure cylinder, between which the printing gap can be adjusted by means of a rocker mounting the die cylinder. An electric drive of the die cylinder makes it possible by means of a three-phase motor supplied by a controllable frequency converter to move the die cylinder diverging from the synchronous speed of the counterpressure cylinder. Reaction forces resulting from the acceleration and deceleration of the electric drive are led directly from the electric drive stator, via a bracket to the machine frame.

The above and further features can be gathered from the claims, description and drawings and the individual features, both singly and in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

An embodiment of the invention is described hereinafter relative to the attached drawings, wherein show:

FIG. 1 A diagrammatic cross-section through the cooperating cylinders of an embossing machine and the mounting thereof without all the other units, considered in the direction of arrow I in FIG. 2.

FIG. 2 A side view of the unit shown in FIG. 1.

FIG. 3 An operating diagram of the drive.

### DETAILED DESCRIPTION OF A PREFERRED EMBODIMENT

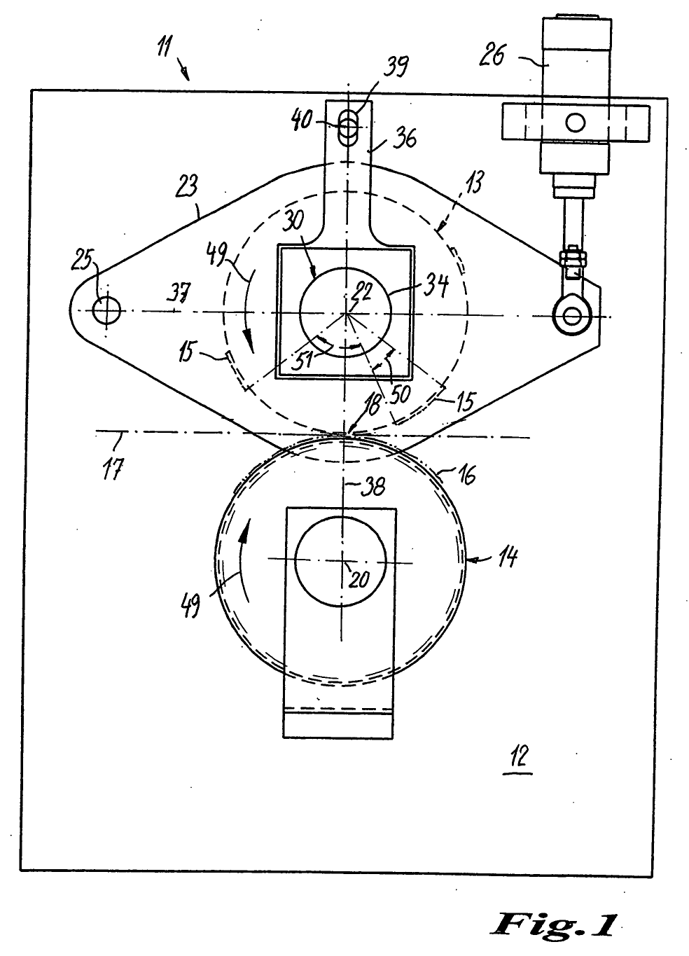

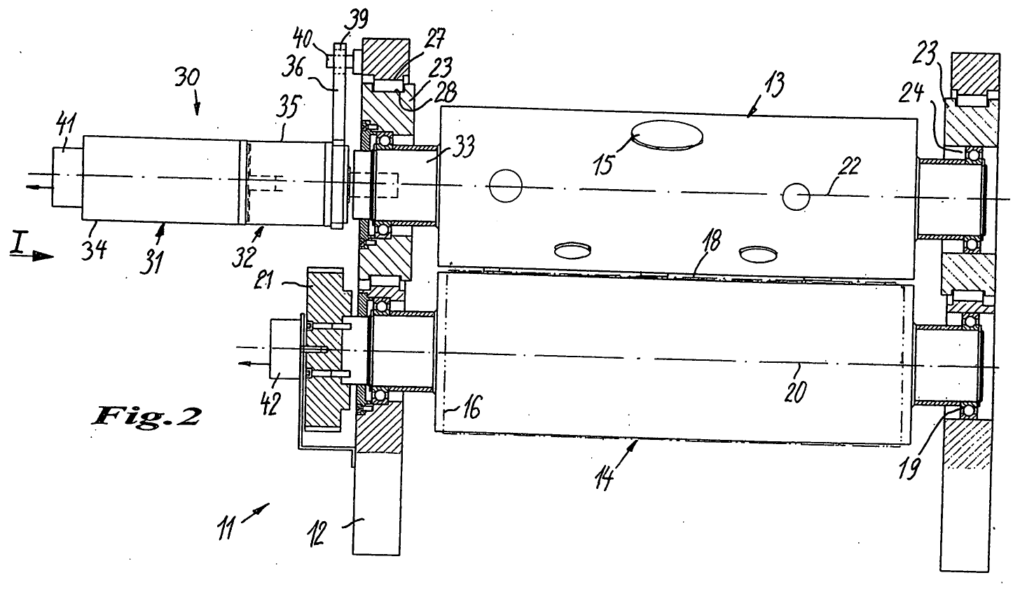

FIGS. 1 and 2 diagrammatically show the embossing unit of an embossing machine 11, whilst being limited to the main functions. As can in particular be gathered from FIG. 2, on a machine frame 12 are mounted two cooperating embossing cylinders 13, 14, whereof the die cylinder 13 carries embossing dies 15, whereas the underlying counterpressure cylinder in the case of a sheet-fed machine has grippers for gripping and holding a sheet 16 (in double dot-dash line form), forming the substrate and on which are embossed surface portions, images, symbols, etc., which are detachably applied to a support web 17 (dot-dash line). The dies are small metal plats (shown in circular, simplified form in FIG. 2) adapted in accordance with the rounding of the die cylinder, with their shape adapted to the surface portion to be embossed and which are fitted by means of clamping devices to the die cylinder or a sleeve applied thereto in accordance with the desired embossing location. The die cylinder is heated in order to apply the surface portions on the support web to the substrate (sheet 16) and for this purpose are covered with a heat seal coating. This can be a matter of holograms, foil images, metal coatings, etc. The support web is passed together with the sheet through the precisely adjustable printing gap 18 between the two cylinders 13, 14 and in certain circumstances for economizing on support foil, the support web can be moved stepwise, optionally also with a decelerating and accelerating path (cf. DE 37 13 666 C, EP 718 099 B and EP 1 155 831 B, to which reference should be made regarding disclosure).

The counterpressure cylinder 14 is mounted in rotary manner about a horizontal axis 20 in bearings 19 in the machine frame. It is driven by means of a pinion 21 by a synchronous drive of the overall embossing machine, i.e. it is synchronized with the remaining units, such as sheet supply, gripper operation, etc.

The die cylinder 13 is mounted about an axis 22 parallel to the axis 20 and specifically in a machine part 23 movable with respect to the machine frame 12 and referred to hereinafter as a rocker. The rocker carries the bearings 24 mounting the die cylinder. FIG. 1 shows that the rocker, which has a side plate on each side of the die cylinder, is so mounted on the machine frame about axis 25 that it can be pivoted by a linear drive 26, e.g. a hydraulic cylinder or an electric linear motor or a spindle drive or the like for the precise setting of the printing gap 18. The connecting line between the pivoting axis 25 and the die cylinder axis 22 is roughly horizontal and therefore perpendicular to the connecting line between the axes 20, 22 of the two cylinders.

It can be seen that the rocker 23 is received by a rib 27 on a cutout of the machine frame receiving the rocker in conjunction with a groove 28 in the outer contour of said rocker for the axial guidance of the die cylinder.

The die cylinder 13 is driven by an electric drive 30 and with respect to its drive it is not mechanically coupled with the synchronous drive of the counterpressure cylinder. The electric drive has an electric motor 31, specifically a three-phase motor, which is optionally directly connected by means of a series gear 32 to the shaft 33 of the die cylinder 13.

The electric motor stator 34 which is flanged onto the case of the series gear 32 is not fitted to the rocker. The stator-gear case unit 35 is provided with a bracket 36, as can be seen in FIG. 1, substantially vertical to the rocker extension or its connecting line 37 between axes 22 and 25 and therefore running roughly in the direction of the connecting line 38 between axes 20 and 22. The bracket is supported with a slide fit in the form of an elongated hole 39 on a stop pin 40, which is fixed to the machine and projects from the machine frame 12. Each of the two cylinders 13, 14 is provided with a pick-up 41, 42 giving the rotation position, rotation frequency or speed, etc. of the cylinders in the form of electric signals to a control.

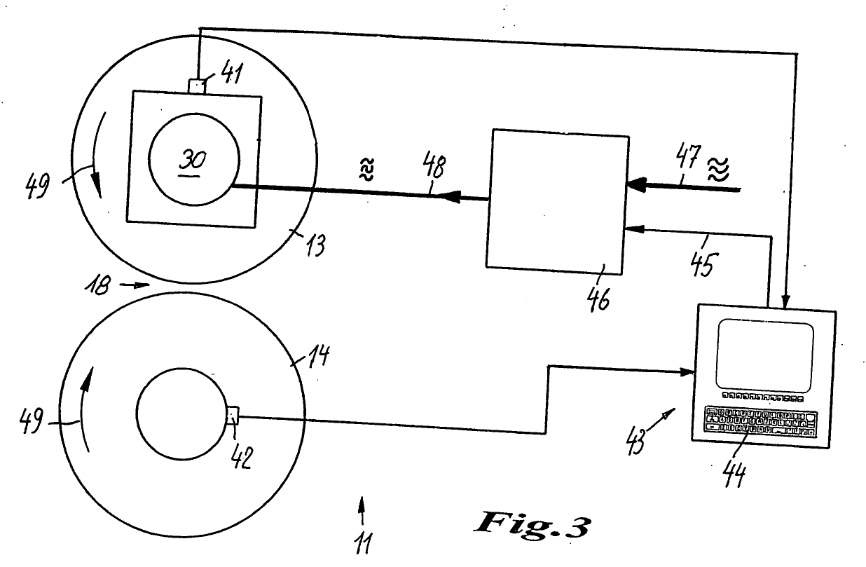

Said control is diagrammatically illustrated in FIG. 3. The signals of pick-ups 41, 42 are supplied to a control device 43, which is shown in the form of an electronic computer. The latter contains an input keyboard 44 and a memory for an operating program and for input values. As a function thereof output signals are generated and supplied by means of a data output 45 to a speed control 46, which contains a controllable frequency converter. The latter produces from a current supplied from the mains via a line 47 a three-phase current, whose frequency precisely corresponds to the desired speed of the electric drive 30 to which it is supplied by means of the three-phase current connection 48.

Function

The substrate 16, e.g. in the form of a sheet which is to be printed or provided with embossings is supplied to the embossing machine, in that a not shown gripper bar in the counterpressure cylinder 14 grasps it and places it round the cylinder. The support web 17 for the surface portions to be embossed is also guided through the printing gap 18 and is so moved by a not shown foil drive that the surface portions to be embossed, the dies 15 bringing about the embossing and the points on the substrate 16 provided for embossing purposes are simultaneously located in the printing gap and have the same speed or circumferential speed.

Using the linear drive 26 the printing gap has been precisely set, so that the pressure necessary for embossing is exerted without damaging the substrate and the support web and the heat from the heated die cylinder 13 brings about the sealing of the surface portion to be embossed on the substrate and the release from the support web. This setting is accompanied by the pivoting of rocker 23 and this is not prevented by the bracket 36 as a result of its slide fit 39.

As a result of the synchronous drive of the embossing machine, the counterpressure cylinder 14 is driven with a predetermined, constant speed. In an ideal case with the effective diameters of circumferences of both cylinders 13, 14 identical, the control device 43 supplies said speed communicating to it by the pick-up 42 as an input signal via data output 45 to the speed control 46, which generates a three-phase current, whose frequency corresponds to said speed, account naturally being taken of any slip, the transmission ratio of the series gear, etc. A back-indication is received by the control device by the pick-up 41 on the die cylinder, so that the latter precisely sets the speed.

If there is a divergence between the effective diameters, which e.g. in the case of the die cylinder are defined as a travel circle over the die surfaces whilst taking account of the embossing depth, etc., then by means of the program filed in the control device a nonuniformity drive for the die cylinder is produced. Its conditions are normally such that during the engagement of the dies 15 with the support web, substrate and counterpressure cylinder the circumferential speed of the die cylinder precisely corresponds to the speed of these components, i.e. the counterpressure cylinder circumferential speed determined by the rotational speed and diameter. Naturally and as indicated by arrows 49 in FIG. 1, the cylinders 13, 14 contrarotate.

In the embossing pressure-free gaps or intervals, it is now possible to increase or decrease the die cylinder speed. This is possible through the frequency control of the electric motor, even at higher speeds, in fractions of a revolution, i.e. within one revolution and optionally also several times. After restoring synchronism over an angle 50 corresponding to a peripheral die extension (e.g. through acceleration compared with the synchronous speed), in the rotation angle range 51 remaining up to the next die 15, a corresponding compensation (e.g. corresponding deceleration) could be initiated so as to again achieve the average synchronous speed on this portion of the circumference.

However, it is also possible through deliberate variations therefrom to set dies to register accuracy. If e.g. the circumferential spacing between two dies 15 is somewhat larger than the corresponding spacing on the substrate provided for the embossings, by increasing the speed over angular portion 51 a compensation thereof is possible.

All that is important is that, over a revolution, an average speed is produced which corresponds to the synchronous speed of the counterpressure cylinder, so that the dies, e.g. in the case of a sheet-fed machine, are always used at the same point of the substrate. However, also here deliberate divergences are possible.

The corresponding settings for the magnitude of the synchronous, accelerating or decelerating sectors, the extent of the divergences, the necessary acceleration and deceleration values, etc. can be inputted by means of keyboard 44, filed in an input memory and processed together with the basic program from the program memory, whilst taking account and correcting the pick-up signals for speed control. The setting can also be vividly illustrated by a graphic representation of the speed variations or a setting by modifying a speed diagram.

Particularly in the case where at higher speeds greater speed variations occur, e.g. as a result of larger diameter differences, not inconsiderable accelerating and decelerating moments are produced by the electric drive. This is not a problem from the energy standpoint, because the braking energy can be fed back again. However, the moments could have a negative effect on the mounting support of the rocker which is movable for setting purposes, if the torques are transmitted to the rocker by means of the unit formed by the gear case and the electric motor stator 32, 34, hereinafter referred to as stator for simplification, so as to expose the same to constantly changing forces.

To avoid this the stator is not flanged to the rocker, but is instead directly supported on the machine housing via the bracket 36 to absorb the reaction moments on the motor rotations. Thus, the reaction moments do not act on the rocker and maintain the latter free from forces.

1. Embossing machine for transferring surface portions from a support web (17) to a substrate (16) comprising:
a first cylinder (19) on which a die (15) is located for transferring the surface portions,
the first cylinder (13) is driven by an electric drive (30), which is substantially equiaxial to the first cylinder (13),
further comprising a second cylinder (14),
the substrate (16) and support web (17) are passing between the first and second cylinder and
at least during transfer of the surface portions, both cylinders (13, 14) are driven with substantially identical circumferential speed;
a control device (43) being provided for the electric drive (30), which on the one hand processes synchronous signals concerning the speed of the second cylinder (14) and on the other hand data concerning desired variations from the synchronous speed and converts same into control signals for speed changes of the first cylinder (13) during a revolution of the first cylinder (13).

2. Embossing machine according to claim 1, wherein the electric drive (30) contains an electric motor controllable in speed-variable manner by means of a frequency converter.

3. Embossing machine according to claim 1, wherein control of the electric drive (30) takes place in such a way that diameter differences between effective diameters of the two cylinders (13, 14) are corrected by adjustable, periodic changes to the circumferential speed of the first cylinder (13) within one of the revolutions thereof, the circumferential speed being modified by a substantially constant value over the working circumferential area of a die (15) on the first cylinder (13), resulting in a circumferential path covering a fraction of one of the revolutions, while within a circumferential area not taken up by the die (15) the circumferential speed being modified back in an opposite modifying direction to compensate said the circumferential path within said one revolution.

4. Embossing machine for transferring surface portions from a support web (17) to a substrate (16) comprising:
a first cylinder (19) on which is located a die (15) for transferring the surface portions,
the first cylinder (13) is driven by an electric drive (30), which is substantially equiaxial to the first cylinder (13),
further comprising a second cylinder (14),
the substrate (16) and support web (17) are passing between the first and second cylinder and
at least during transfer of the surface portions, both cylinders (13, 14) are driven with substantially identical circumferential speed;
the electric drive (30) driving the first cylinder (13) having an electric motor (31) with a stator (34, 35) and a rotor, the stator being mounted on a machine part (12) different from the first cylinder (13).

5. Embossing machine according to claim 4, wherein the first cylinder (13) is mounted on a machine part (23) mounted on the machine frame with an adjustable spacing from the second cylinder (14) and that the stator (34, 35) of the electric drive (30) rotatably mounted with respect to the rotor is supported by a bracket (36) on the machine frame (12).

6. Embossing machine according to claim 5, wherein the support arm (36) extends substantially vertically to the adjustable machine part (23) and between it and the machine frame (12) is provided a connection (39) movable substantially in the longitudinal direction of the bracket (36).

7. Embossing machine according to claim 5, wherein the bracket (36) has its support mounting roughly in the extension of the pivoting axis of the adjustable machine part.

8. Embossing machine according to one of the claims 4 to 7, wherein the adjustable machine part (23) is held adjustably by means of a linear drive (26), such as a hydraulic cylinder.

9. Embossing machine for transferring surface portions from a support web (17) to a substrate (16) comprising:
a first cylinder (19) on which a die (15) is located for transferring the surface portions,
the first cylinder (13) is driven by an electric drive (30), which is substantially equiaxial to the first cylinder (13),
further comprising a second cylinder (14),
the substrate (16) and support web (17) are passing between the first and second cylinder and
at least during transfer of the surface portions, both cylinders (13, 14) are driven with substantially identical circumferential speed;
a control device (43) being provided for the electric drive (30), which on the one hand processes synchronous signals concerning the speed of the second cylinder (14) and on the other hand data concerning desired variations from the synchronous speed and converts same into control signals for speed changes of the first cylinder (13) during a revolution of the first cylinder (13),
the electric drive (30) driving the first cylinder (13) having an electric motor (31) with a stator (34, 35) and a rotor, the stator being mounted on a machine part (12) different from the first cylinder (13),
the control of the electric drive (30) taking place in such a way that diameter differences between effective diameters of the two cylinders (13, 14) are corrected by adjustable, periodic changes to the circumferential speed of the first cylinder (13) within one of the revolutions thereof, the circumferential speed being modified by a substantially constant value over the working circumferential area of a die (15) on the first cylinder (13), resulting in a circumferential adjustment path covering a fraction of one of the revolutions, while within a circumferential area not taken up by the die (15) the circumferential speed being modified back in an opposite modifying direction to compensate said the circumferential adjustment path within said one revolution.
